(19) United States
(12) Patent Application Publication
(10) Pub. No.: US 2007/0052726 A1
(43) Pub. Date: Mar. 8, 2007

(54) Method and system for likeness reconstruction

(76) Inventors: David Wright, Seattle, WA (US); Marcia Broderick, Mercer Island, WA (US)

Correspondence Address: John P. Luther, Esq.;Jenkens & Gilchrist, Suite 2600, 225 W. Washington street, Chicago, IL, 60606, US

(21) Appl. No.: 11/222,148

(22) Filed: Sep. 8, 2005

(51) Int. Cl. G09G 5/00

(52) U.S. Cl. 345/629; 345/419

(57) ABSTRACT

The present invention provides a method and system for the efficient and accurate facial likeness reconstruction or composite generation from a witnesses' recollection as performed in conjunction with cognitive interview techniques employing a selection menu of facial features or other facial accessories from pre-selected groupings of such features and accessories.

### FIELD OF THE INVENTION

The present invention relates to a method and system for a computer program-aided generation of a composite of an individual's facial likeness.

### COPYRIGHT NOTICE

Copyright 2005 David Wright and Marcia Broderick. All rights reserved. A portion of the disclosure of this patent document/patent application contains material which is subject to copyright protection. The copyright owner has no objection to the facsimile reproduction by anyone of the patent document or the patent disclosure as it appears in the U.S. Patent and Trademark Office files or records, but otherwise reserves all copyright rights herein.

### BACKGROUND OF THE INVENTION

Identification techniques have been an important tool in law enforcement areas for many years, if not centuries. The importance of the effectiveness of such techniques has never diminished over time, and are now probably in greater demand than ever before in criminal investigations and other areas where picture identification is not available. Typically, in conventional approaches, a composite facial reproduction of an individual is produced by an artist after or during conference with an eyewitness, which may be a lengthy hit or miss affair, and with accuracy depending, at least in part, upon a witnesses' ability to accurately articulate what was actually observed. Although new technology and methodology has evolved to hone the accuracy of an artist's composite sketch of facial features as described by a witness, there still exists a common problem of accurately translating the description of an eyewitness into a true image due to a number of factors, such as the memory of an eyewitness to accurately recall facial characteristics and articulate such recall to an artist.

To improve the accuracy of facial composite reproductions, several new computer-aided approaches have appeared in recent years. For example, U.S. Pat. No. 6,731,302 describes a composite picture system which employs a library of basic facial components to create facial images. In contrast to conventional methods which employ steps of selecting various facial components, (“morphological elements”) from a library for assembly, this method uses a component calibration step which is said to allow for different basic coded morphological elements of a facial image to be merged into a single synthetic facial image with proportional components. This method also reports the use of a universal skin tone which is created by using a set of filters on original images. The encoding of a morphological image library is also said to improve efficiency. In operation, a user selects through an interface basic morphological elements from a library of such elements. For a given facial image, a single basic morphological element is selected from a given morphological class and combined with other elements, eventually forming an image with the universal skin tone used to tie any voids together. This method, like many others, however, is still dependent on the imperfect memory of the user who, as in many conventional techniques, is faced with an extensive and oftentimes overwhelming array of features to choose from.

U.S. Pat. No. 6,661,906 describes another image reconstructing method which employs a device for receiving inputted image data, a device for storing image component data, a selection device for receiving selection input data for one or more image classes, a control device for selecting image component data from the storage device based on character quality and a “select rule” of image component data. In operation, an image or a portrait is created based on face image data entered by the image input device, with such data corresponding to a selected image class such that plural types of images or portraits having different styles and expressions can be created based on entered single image data, or face image data. Image components as selected by a “select rule” in which an image is selected according to an image class. The so-called select rule is determinative via a complex set of measurements inclusive of, for example, a “rule library” which includes a “select rule library”, a “deform rule library” and an “arrange rule library”, each of which is said to store a “rule group”. A “rule group” is said to consist of a plurality of rules about a group or class of images i=1 ton for each facial component selection, deformation and determination of an arrangement position processed, such as an eye image or face component, by an eye being specified in image data applied by a predetermined image process, an angle between a center line of eyes and a horizontal line, a width “x” of an eye, a height “x” a spacing “d” and a distance “h” from the center line of the eyes to a chin. A select rule group as based on a previously selected “i” is read out and angles “o”, “x/y” applied to an eye slant rule and roundness eye rule. As may be readily discerned, such a complex system may find complications of application in refreshing the recollection of a perhaps surprised or excited witness.

In another example, U.S. Pat. No. 5,818,457, discloses a face image data processing device which processes data on a face image to create a face image suitable for an age, and presumes the age of the created face image via an age designating unit, and in which respective part images corresponding to the designated age data are read from a storage base. Again, the accuracy of recollection and reconstruction of the underlying facial image is problematic.

U.S. Pat. No. 5,375,195 provides a method and apparatus for generating a composite of an individual face, by a person not skilled in computer use, and supposedly without the need for a person's recall of particular facial characteristics. A randomly determined set of facial composite prints is generated from which an unskilled witness can rate the relative likeness thereof to an observed face on a numeric scale, followed by successive generations of computer-generated groups of facial composite prints generated by a generic algorithm, and from which an unskilled witness can continue to rate the likeness until a satisfactory facial composite is finally achieved. More particularly, in this method, a facial composite of a human face is generated by first generating a set of facial composites, then identifying a “fittest” facial composite of the set and combining this so-called fittest facial composite and another facial composite from the set to create an intermediate facial composite. The intermediate facial composite is then placed in the set and all of the above steps are repeated until the intermediate facial composite is satisfactory.

In the first step, a set of facial composites is initially obtained by randomly generating the set after initially limiting the universe from which the set of facial composites is generated by sex, race, and other identifying characteristics. A set of unique strings of binary digits is then generated with each of the strings corresponding to a unique facial composite, and with each of the composites being rated by a user on a scale of fitness to an observed human face. The rating is also performed or supplemented by measuring physiological responses of the user.

The fittest facial composites are combined with other facial composites by breeding two genotypes corresponding to the fittest facial composite and another facial composite to generate an offspring genotype corresponding to the intermediate facial composite, and with permitting genotype breeding by cross-over of genes between two bred genotypes with a probability of 0.24 and mutation of genes within the two bred genotypes with a probability of 0.05. This system is said to be advantageous in its reliance on recognition rather than recall, as a witness who is unable to recognize an observed face will be presumably unable to accurately recall facial features, but such a witness may recognize an observed face without possessing the ability to recall all or some of the separate features of the face. Thus, the method is said to operate independently of the cognitive strategy employed by a witness, by supposedly allowing a witness to pursue an individual approach. This method is also said to advantageously eliminate any biasing influences introduced through a human interview and as not requiring the use of an extensive set of questions about the observed individual prior to generating a composite facial likeness.

Another computerized facial identification system is disclosed in U.S. Pat. No. 5,057,019 in which a database is created by a computer which includes a plurality of digitized portions of a face taken from a photograph. This system extols the advantages of creating a database for a facial feature identification system from facial photographs of real people by employing electrical signals derived directly from sensors in a camera developed from photographs of real people, and from also employing partially digitized facial images of portions of a photographed face which can be selectively changed on a television screen to display different full facial images in accordance with a verbalized recollection description of an observed face.

U.S. Pat. No. 5,649,086 describes the reproduction synthesis of a human face by combining and modifying exemplar image portions that are indexed as to characters and parameters, and which are arranged into a hierarchical network. A plurality of features which make up the identifying detail of a facial image are associated into “child networks”. “Parent networks” said to be under the control of higher-level parameters control the child networks to produce an image with separate child networks provided for various facial features, such as hair, eyes, nose and mouth, and which are hierarchically arranged into one or more parent networks to produce a facial image. As in practically all conventional systems, images are synthesized by the user's selection of parameters, as established by correspondences between exemplar images of each of such facial features and parameters by which features are defined, and the assembly of the various features into an overall image. Parameter values are selected by a user, and the synthesis of an image is performed based on the selected parameters, again as based upon the recall ability of a user.

In a more recently described method, in U.S. Pat. No. 6,549,200 there is provided the modeling of an image representing a three-dimensional object such as that of a person's face. This is a fairly complex method of modeling by a stored set of parameters representing a model of a three-dimensional object and at least two two-dimensional images of the object, with each image representing the object, from a unique direction of view, and with parameters comprising parameters which define the positions of a plurality of vertex points in a virtual space and parameters defining relationships between vertex points and surface elements of the object. The advantages advanced for this method are a rapid labor saving and less arduous method for the operation of a synthetic two-dimensional display of a head, such that the image seen in the display appears as it is seen from any desired viewpoint, or a sequence of such images to provide animation, as based on a “wire-frame” model. As in other methods, however, this method is also limited by the accuracy of recollection by an eye-witness of facial features and their spatial relationship and arrangement to one another, and is really intended to work with actual photographs and not reconstructed facsimiles.

U.S. Patent Application Publication No. 2003/0065255 provides a method and system said to enable simulated use of aesthetic feature on a simulated facial image. Here, an individual is enabled to construct a simulated facial image using a facial construction computer program, and in which the computer program permits and individual to select at least one of head, eyes, nose, lips, ears and eyebrows as aesthetic features and to simulate its use as viewed on a display device. In essence, this method is yet another rendition of conventional technique in which a computer program is used to construct a facial image by selecting facial portions and/or facial features are constructed by computer in a manner similar to the way a sketch artist would make a profile sketch of, for example, a suspect and the like. Other aesthetic features able to be deployed in this computerized method include, for instance, jewelry, body piercing, tattoos, eyeglasses, or other types of items, substances, services or actions that might potential alter a person's facial appearance. Also included are make-up and beauty articles, such as eyeliner, eye shadows, mascaras, blush, lip liners, lipsticks, lip gloss, hair coloring and the like. In operation, as in most other conventional methods, a user initially selects one of a head, eyes, nose, lips, ears and eyebrows, size and/or shape of the head. The user may also be able to first select a generated category of facial image types, and then be presented with similar choices from which to select. As can be seen, a user attempting to reconstruct a facial image, or in describing facial feature characteristics to another for reconstruction is faced with a withering array of choices which may blur the recollection and perhaps sway the imagination, all of which distract from the accuracy of a facial reconstruction whether performed manually by an artist or computer code techniques.

In U.S. Patent Application Publication No. 20040085324, an image-adjusting system and method is disclosed which employs a set of adjusting parameters by way of a face-adjusting template stored in a database to adjust facial image data. Facial feature adjustment data includes, for example, skin texture, proportion of facial features, variations of expression and the like (“plural face adjustment parameters”), which constitute different face-adjusting templates. Such template construction and use are said to advantageously allow their application on facial images in replacing conventional complicated image processing techniques and in which those not skilled in visual design and/or computer graphics may develop facial imagery. Again, however, this system depends upon the initial use of an original facial image which must be supplied by the oftentimes faulty or cloudy recollection of a witness.

Finally, in U.S. Patent Application Publication No. 20030063794, there is described yet another method and system of enabling a simulated use of an aesthetic feature on a simulated facial image by way of a facial construction computer program. As with other conventional feature construction methods such as surveyed above, this method is problematic in disadvantageously confronting a witness or user with the daunting task of picking and choosing from a possibly overwhelming array of possible head, eye, nose, lip, ear, eyebrow and other facial features, mostly out of context with each other and in a hit or miss initial application. Such initial picking and choosing from a wide array of features virtually in a vacuum is not only inaccurately suggestive or misleading to one's recollection, but may in effect serve to distorts one's memory and fatally skew any resulting facial reconstruction from the outset.

As may be ascertained, there exists an important and long-desired need for an improved facial likeness reconstruction technique, which is more reliable in use, and which does not have the potential to distort a witnesses' recollection of observances, or which does not play a suggestive role in leading a user to think of or lean to a likeness or features which are factually incorrect.

There also exists and important long felt need for such a process as described above which is relatively simplistic in use and/or application such that it may be widely employed by virtually anyone, whether skilled, unskilled or artistically gifted or not.

### SUMMARY OF THE INVENTION

In accordance with that set forth above, the present inventive method and system provides an efficient and accurate method of facial likeness or composite generation from witnesses' recollection in conjunction with a cognitive interview technique employing a selection menu of facial features, or other body features, from pre-selected groupings of such features.

The invention is more fully understood with reference to the following detailed discussion of preferred embodiments with accompanying drawings and the appended claims.

### BRIEF DESCRIPTION OF THE DRAWINGS

FIG. 1 illustrates a representation of one preferred embodiment of the present invention in operation and use.

FIG. 2 illustrates a representation of another preferred embodiment of the operation and use of the present invention related to element selection.

FIG. 3 illustrates a representation of another preferred embodiment of the operation and use of the present invention related to feature selection.

FIG. 4 illustrates a representation of another preferred embodiment of the operation and use of the present invention related to eye selection features.

FIG. 5 illustrates a representation of another preferred embodiment of the operation and use of the present invention related to nose selection features.

FIG. 6 illustrates a representation of another preferred embodiment of the operation and use of the present invention related to mouth selection features.

FIG. 7 illustrates a representation of another preferred embodiment of the operation and use of the present invention related to a scroll bar for scrolling through components and feature selections.

FIG. 8 illustrates a representation of another preferred embodiment of the operation and use of the present invention related to composite modification features.

FIG. 9 illustrates a representation of another preferred embodiment of the operation and use of the present invention related to ear selection features.

FIGS. 9a and 9b illustrate a representation of another preferred embodiment of the invention related to adjustment of selected features.

FIG. 10 illustrates a representation of another preferred embodiment of the operation and use of the present invention related to composite editing features.

FIG. 11 illustrates a representation of another preferred embodiment of the operation and use of the present invention related to feature distortion.

FIGS. 12a and 12b illustrate a representation of another preferred embodiment of the operation and use of the present invention related to feature selection, symmetry and manipulation.

FIGS. 13a and 13b illustrate a representation of another preferred embodiment of the operation and use of the present invention related to element behavior.

FIG. 14 illustrates a representation of another preferred embodiment of the operation and use of the present invention related to a checklist feature.

FIG. 15 illustrates a representation of another preferred embodiment of the operation and use of the present invention related to a flowchart example.

### DETAILED DISCUSSION OF PREFERRED EMBODIMENTS

All patent references, published patent applications and literature references referred to or cited herein are expressly incorporated by reference. Any inconsistency between these publications and the present disclosure is intended to and shall be resolved in favor of the present disclosure.

In the following discussion, many specific details are provided to set forth a thorough understanding of the present invention. It will be obvious, however, to those skilled in the art that the present invention may be practiced without specific details, and in some instances of this discussion with reference to the drawings, known elements have not been illustrated in order not to obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware or software, or some combination thereof. In some preferred embodiments, the functions are performed by a processor such as a computer or an electronic data processor in accordance with code, such as computer program code, software, and/or integrated circuits that are coded to perform such functions.

Additionally, the processing that is depicted in the drawings and described below is generally depicted as hierarchical in structure for readability and understandability. However, various other methodologies, such as object-oriented techniques, may be preferred for various physical embodiments of the invention in order to maximize the use of existing programming technique. One of ordinary skill in the art will appreciate that the techniques described herein may be embodied in many different forms.

For illustrative purposes only, the following discussion illustrates and discusses the present invention in reference to various embodiments which may perhaps be best utilized subject to the desires and subjective preferences of various users. One of ordinary skill in the art will, however, appreciate that the present invention may be utilized to enhance one's cognitive interviewing skills and enhanced accuracy and efficiency in composite facial reconstruction in general.

Having thus prefaced this discussion, the present invention provides a new and unique, much simplified method of facial likeness reconstruction or facial composite generation which is more accurate than conventional methods and much less prone to confuse witnesses' recollection or memory of facial facts. The present invention also enables the accurate generation of a facial composite or likeness in a relatively short time period with respect to many conventional techniques.

In accordance with the invention, a cognitive interview technique is employed with a selection menu of facial features which are provided in pre-selected portions, or an array of pre-selected portions, in contrast to confronting a witnesses' with a confusing and withering selection from many thousands of possible noses, mouths, foreheads, eyes and other features as in conventional practice.

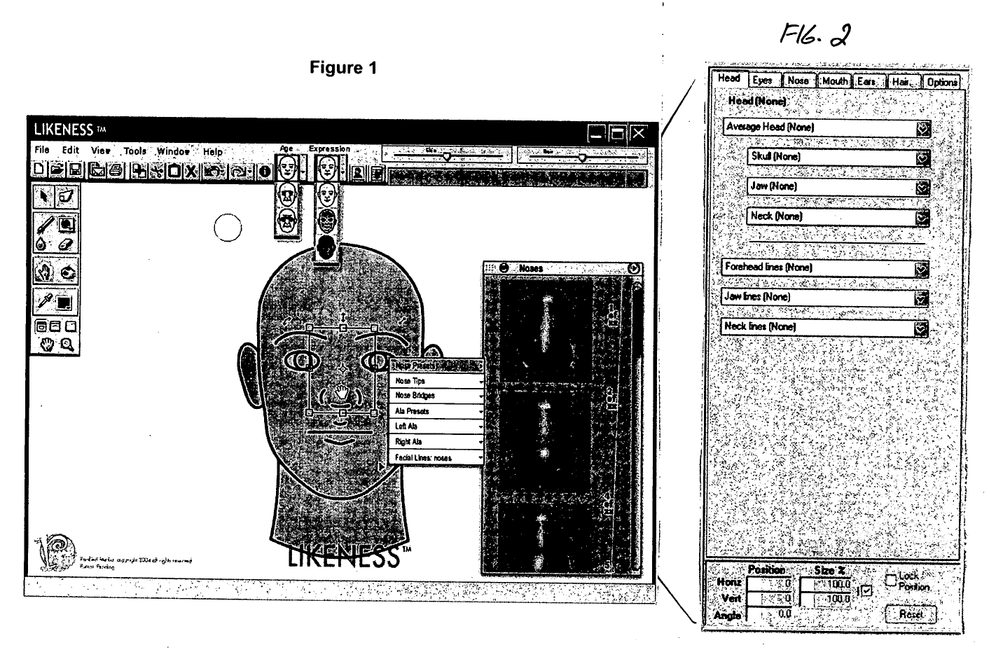

As well known, facial composite images are a mainstay of eyewitness identification when a suspect's or person's identity is unknown, or when a line-up identification or mug shot identification by a witness is unsuccessful. Usually under such circumstances, a witness is requested to participate in a question and answer process to aid in the fabrication of a facial composition oftentimes by a sketch artist or a computerized method, such as surveyed above. Referring now to FIG. 1, in a preferred embodiment of this invention, in contrast to conventional methods, there is illustrated a user interface mock up inclusive of a generic head portion on a screen provided with pre-selected groups of facial features which are moveable, distortable, and/or manipulatable, as to spatial and topography relationships relative to the head portion, such as noses, eyes, eye coloring, eyebrows, mouths, chins, cheeks, hair, hairlines, facial coloring, teeth, lips, ears, foreheads, and skin coloring, with possible physical deformities, such as scars, skin lines and wrinkles, freckles and moles and the like, and facial accessories, such as sunglasses, eyeglasses, contact lenses, earrings and piercings, such as nose and eye rings and bars, toupees, beards and other facial hair, and various tattoos, and any sort of facial makeup and cosmetics and mixtures thereof. The generic head portion may be selected from a simplified menu of North American, European or otherwise Caucasian types in addition to Latin, Asian, African American, Negro, African, American Indian, and Indian versions, and/or mixtures thereof and the like to reflect mixed ancestral backgrounds and intermarriage between various races, with an assortment of hair and skin tones available, such as light, medium and dark tones. The generic head portion as depicted on the screen may also be flipped from side to side, or rotated on a vertical axis as desired, or paralleled in vertical and horizontal sections with different sections accommodating different types of facial features for comparison, such as a tangentially angled view of one type of an eye or eye/eye brow and nose combination vs. another type of such combination.

In one preferred embodiment, the inventive method enables an interface with such facial features and accessories by way of drag down or pop-up, or other displayed features/accessory menus, for point-and-click simplicity and convenience, and optionally supplied in accordance with a zoom tool or feature. A positioning tool or capability is also supplied to enable the placement or positioning or re-positioning of features and/or accessories on a generic head portion as desired. Additional features include a blending feature by which a facial feature, such as a nose or lips, may be pointed at a position thereof and widened or narrowed, or miniaturized, reduced or enlarged in a general manner as desired by a user, an artist or witness alike. In other embodiments, generic head portions and/or facial features may be accessible in a plurality of age selections, such as by decade, be it 20, 30, 50 or 50 plus years of age or a juvenile selection may be provided. A selection of standard military or other hair fashions may also be made accessible, as well as various portions of an assortment of lifestyle accessories, such as, for instance, uniforms, such as that of a garage mechanic, a construction worker, hospital and health industry attire, student attire, a sailor's attire, a businessman's attire, biker garb, police officer attire and the like. Uniform portions of military uniforms of different counties, or garments typical of different countries is also an option, as well as different dental configurations, such as buck teeth, gold teeth or no teeth.

In any event, in accordance with the present invention, a witness or victim, or any likeness recollector is provided with a pre-selected menu from each category of head portions, features and/or accessories at the outset from which to choose from during a cognitive interview session, such as not to overwhelm a witness with thousands of possible facial features and the like, or more importantly to not supply improper suggestion, perhaps by a form of subliminal suggestion from briefly glimpsing many possible choices, and swaying the imagination of a witness to choose incorrect features and/or accessories, or otherwise enable distortion of one's recollection. To further simplify matters, cognitive interviewers may, upon interviewing the witness, decide to start with selecting a head portion on their own without requiring a decision from the witness, to further reduce or eliminate any possible confusion on the part of the witness.

The phrase “pre-selected menu” as used herein refers to finite groups of each of a plurality of different races and mixed races of head types and facial features, or otherwise “head and facial facts” inclusive of eyes, noses, ears, beards, mustaches, hair and facial hair, and physical deformities, such as moles, scars, and the like, and permanent and removable accessories, such as eyeglasses, cosmetic lenses, earrings, tattoos, toupees, etc., and lifestyle garb, such as characteristic attire, comprising any limited number thereof effective not to confuse a witness, or to suggestively corrupt a witness's memory as to head and facial facts. Such a numerical range may be ascertained by simple experimentation without undue effort, such as by conducting interviews with witnesses as to practice reconstructions, with different people having, of course, differing recollection abilities. At any point in the inventive method a witness may be asked if a selection is so numerous as to interfere with their memory. However, in most instances, it has been found that it is preferable to include from 1 to about 30 of such features in a pre-selected group, and most preferably from 1 to about 20, or even less, such as 4 to 10 choices. In accordance with the invention, it has been found to be unexpectedly advantageous and effective to offer a witness a selection of such features from pre-selected groups, as such avoids, or at least substantially avoids, confusing a witness's memory as to head and facial facts, and substantially lessens any tendency of suggestively corrupting a witness's memory.

In a preferred embodiment of the practice of this invention, a witness undergoing an interview as to his or her recollection of head or facial facts will not be able to view a likeness reconstruction in progress, so as not to prejudice, or suggestively corrupt, a witness's memory by showing a possible distortion of a likeness or head and facial facts to a witness, or a witness may only be allowed substantially limited viewing, such as when a likeness is nearly or substantially complete.

Additional features of the present invention include the availability of component images which are gender non-specific with the exception of hairstyles and the like and the ability to mix and match sub components, such as upper and lower lips, nose nostrils, nose bridge and tip, and skin and hair tone. A program will automate facial placement or feature symmetry, which can be overridden by another feature of the invention to more closely approximate how people really look. Further component images may be distorted, scaled, rotated or painted, such as the application of makeup in selected tones or hues to selected facial portions. By way of using a pre-selected number of facial feature components and/or accessories, and the ability to move, distort and/or manipulate same in virtually any manner in relation to a head portion, a witness is not prone to become confused or overwhelmed at the outset, or during the cognitive process, or be less prone to adopting incorrectly suggestive components, but will still be able to create with the inventive method and system virtually any face and/or or upper body portion, such as inclusive of the top one's shoulders and neck portions, without the need for accessing a huge and problematic database of images and/or accessories, as one is confronted with in conventional processes.

Furthermore, in additional preferred embodiments of the invention, a user or witness may select from a menu of preset expressions ranging from happy to enraged, as well as being provided the ability to “age” an image gradually or as rapidly as desired, such as by facial lining, or by other subtlety, such as by impacting indications of advancing age inclusive of eye wrinkles, or facial lining, or the inclusion of age spots and/or a subtle but predictable receding of a hairline or puffing or meatiness of one's face, or perhaps a thickening neck or the beginnings of a double chin formation.

As mentioned above, any type of scar or other skin abnormally, such as moles, rashes, freckles, facial lines and wrinkles or even pimples and blackheads and the like are contemplated for use herein, any of which may be positioned and/or distorted and/or manipulated to any degree as desired.

In yet additional preferred embodiments of the invention, notwithstanding what facial features are selected for use or no-matter how such are distorted, programming techniques are employed to blend images together seamlessly, or substantially seamlessly, to provide as realistic an image as possible and substantially similar to the actual likeness to eliminate, or at least substantially reduce, the need for touch-up procedures, which may also tend to distort or suggestively corrupt a witnesses' recollection and sway imagination.

In still yet further embodiments, a witness is confronted with an initial selection from pre-selected categories of images which are less that realistic in portrayal which allows an interviewer to describe general characteristics and perhaps symmetry without prejudicial effect or again without suggestive corruption of one's recollection or memory.

Still additional features include a varying opacity of components, features or accessories from 0 to 100 percent, and the ability to add or delete, show or hide, or lock or unlock or change any layering order for increased flexibility.

A background imaging capability is also provided, such that images may be imported into an application of likeness reconstruction as a background layer, such as in a situational setting or scenario recollection. Background components may be placed at will or as desired.

Still other features of the present invention allow the import of specified skull images such as suggested by forensic pathologists, before or after a witness interview. In this embodiment, a user may insert such a feature and then proceed to build an overlay image of a persons' likeness, such as recalled by a witness of a prior session or before any witness session. Layer opacity may also be used with transform tools to match components such as ears, nose and the like to inputed forensic markers or targets in a background image or overlay (or underlay).

In still other embodiments, a component/facial feature or accessory selection panel may be provided as a pull down or pop up menu and the like, such as by right clicking a mouse feature on a nose or eye or forehead region, with sub-menus possibly containing nose rings, nose topographies, such as pimples or blackheads and glossy, red or bright eyes and the like. In other preferred aspects and embodiments, a user or witness alike may be shown on a tab or selection panel an array of pre-selected choices for the feature or accessory selected by way of a contextual menu, and be able to visualize and select all transformations and components by clicking any on the generic head.

In operation, in the grouping feature of the invention, for example, in the case of a nose, say, from x selections, a user is provided with a choice, for example, of a limited number of components, such as, four components, each of which may be manipulated separately, such by a point and drag technique with a mouse device. Of course, the entire nose may be moved as well, or scaled (reduced, enlarged) or rotated at will, or any portion of the nose feature moved, distorted, scaled, and/or manipulated in any manner as desired. The same may be performed on a mouth, lip, eye, iris, forehead, and cheek selection and the like, with undo and redo features, such as provided in an edit menu feature, actuatable, for example, by a mouse means. A grouping and selection of multiple components/features or accessories is also contemplated for convenience and ease of construction, depending upon, inter alia, the quality of a witnesses' recollection.

As shown in FIGS. 1 and 2, there is exemplified a preferred embodiment of the invention with a user interface mockup (100) on a display screen (102) with a Likeness™ Main Tool Bar™, or Likeness™ Composite Element Selection Tool™. This tool bar may be in the form of a Windows application standard toolbar which provides access for rapid commands from a user, such as New, Open, Save, Copy, Print, Cut, Paste, Delete, Undo, Redo, and additional commands in accordance with the invention, such as the standard commands of Interview Info Checklist, Cognitive Interview Checklist, Emoticon Normal, Emoticon Sneer, Emoticon Agony, Rotate Right, Rotate Left, Size Increase, Size Decrease, Darken, Light, Tilt to 0-180° and the like. Canned expressions may also be available in this menu. In this embodiment, there are generally three primary functional areas, the menu and tool bar (104) at the top of the screen for access to commands, a stage area (106) to the left of the screen where the composite head is constructed and edited, and a component panel area of FIG. 2 (108) to the right of the screen, which is in somewhat exploded view in this illustration for comprehension purposes, where primary editing tools are located, with panels containing separate groups of functionality. The application is preferably optimized to function at screen resolutions of 800×600 and greater. As illustrated in FIG. 2, the component panel area (108) may contain a composite element selection tool or “picker” for editing or selecting composite parts or facial features, and a series of adjustment tools, for example, to manually select the position, size or rotation of selected features.

Additional embodiments contemplated herein are the inclusion of emoticons or canned expressions, as described above, and a “Wanted Poster” display with the ability to enter text and save out a final image with the text to JPEG (Joint Photographs Expert Group) format and the ability to e-mail a finished composite of a wanted posted with the click of a button.

As also shown in FIG. 1, in this preferred embodiment, the component panel area (108) comprises as primary editing tools interfaces for adjusting a part of a composite's image, such as, in a preferred order, the head, eyes, nose, mouth, ears, hair and options. As exemplified in this embodiment, the nose tab has been selected which provides a display of noses, as shown, with sub-editable features, such as nose presets, left ala, right ala and nose facial lines, all of which are adjustable as desired.

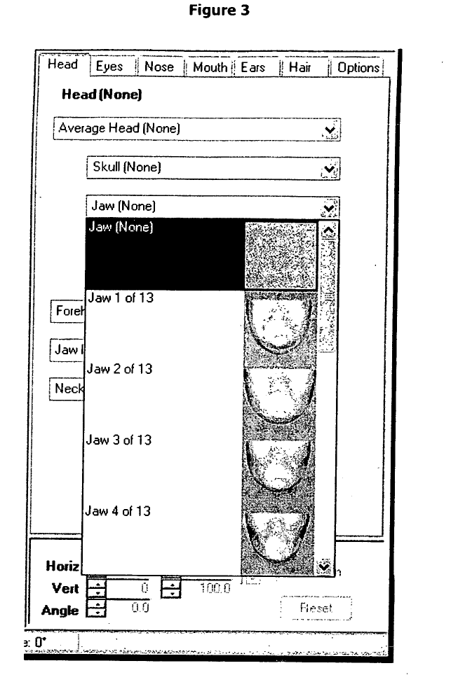

FIG. 3 depicts another illustration of the component panel area with a feature selection tool, and which allows a user to select features and subfeatures, which may comprise a full composite image. In this illustration, 4 of 13 possible jaws are depicted for selection. By having features grouped under tabs, a user or witness may more readily see available options for quick access, and before subjective or subliminal recollection contortion is manifested to any degree. Menus may be in drop down form with thumbnails as shown, or in any convenient presentation or format. In some preferred embodiments, there may be tabs for head, eyes, nose, mouth, ears, hair and options, such as accessories inclusive of ear rings, piercings and the like. As also shown in FIG. 3, a scrollbar for scrolling through pre-built heads or face portions is provided, and which may identify a current head choice, and the number to choose from, and other lists, such as skull, jaw and neck drop down lists.

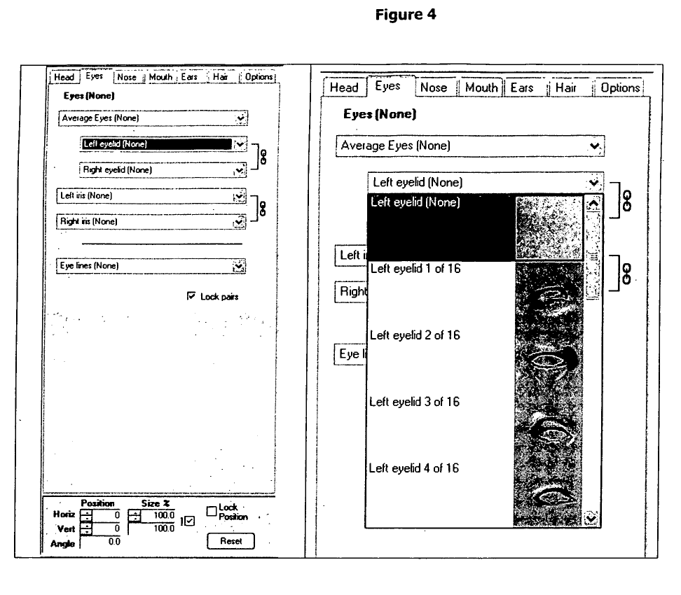

In FIG. 4 an eyes selection tab embodiment is illustrated with dropdowns actuated comprising left eye, right eye, left eye color, right eye color, and the like. A generic default setting may also be enabled, or other features enabled, such as an un-checking feature in which eyes may be added to a composite likeness in non-matched components or in a non-symmetrical manner. Noses may have different options.

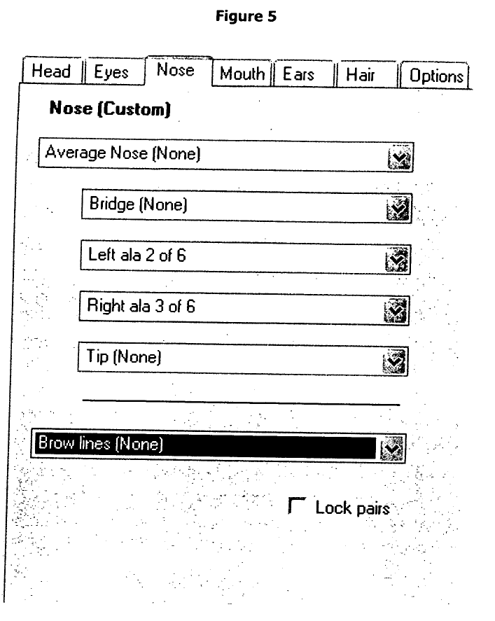

A nose selection tab illustrated is shown in FIG. 5 with dropdowns inclusive of bridge, tip, left ala, right ala, and optionally with sub-components or features such as nose-rings etc. Again, a default setting portraying a generic nose may be provided.

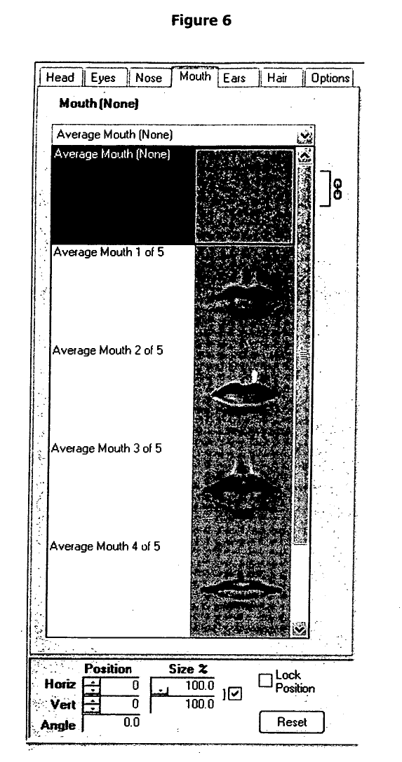

FIG. 6 depicts a mouth selection tab illustration in accordance with the invention, which may also include selections such as an upper and lower lip, and is also optionally equipped with a generic default, or starting or stopping over tab. As shown, a selection from five mouth styles is offered in this embodiment.

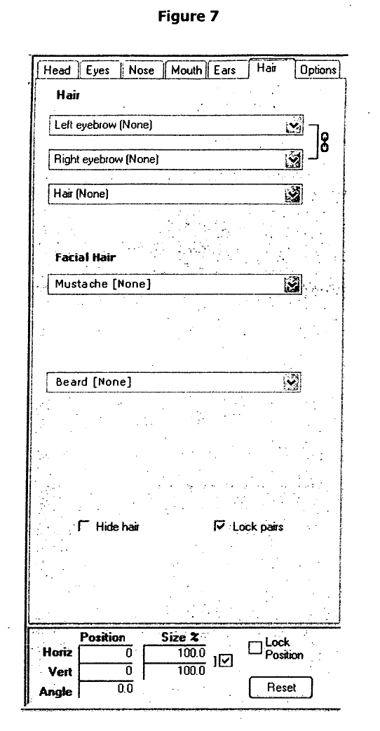

Hair selection is illustrated in the tab of FIG. 7, which may include a scrollbar for scrolling through components as in other feature selections, and with drop down subfeatures including hair, eye brows, mustache, beards, stubble and the like, again with generic default features for each optionally available.

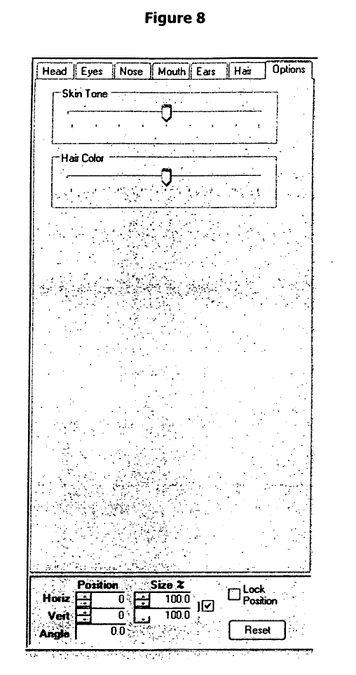

An options tab feature is illustrated in FIG. 8 which may be employed to control or modify a composite on a global level, such as by a skin tone adjustment tool, a hair adjustment tool, and receding hairline and a bald or comb-over tools (not shown), etc. A slider tool which darkens or lightens may be provided or any other tool for providing distinguishable and/or recognizable features.

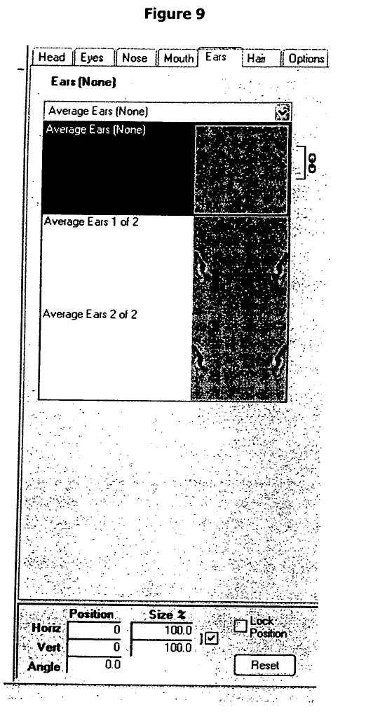

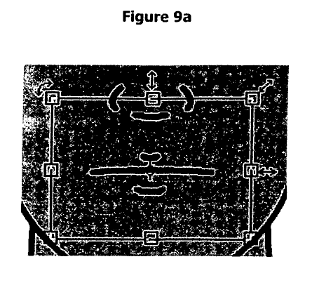

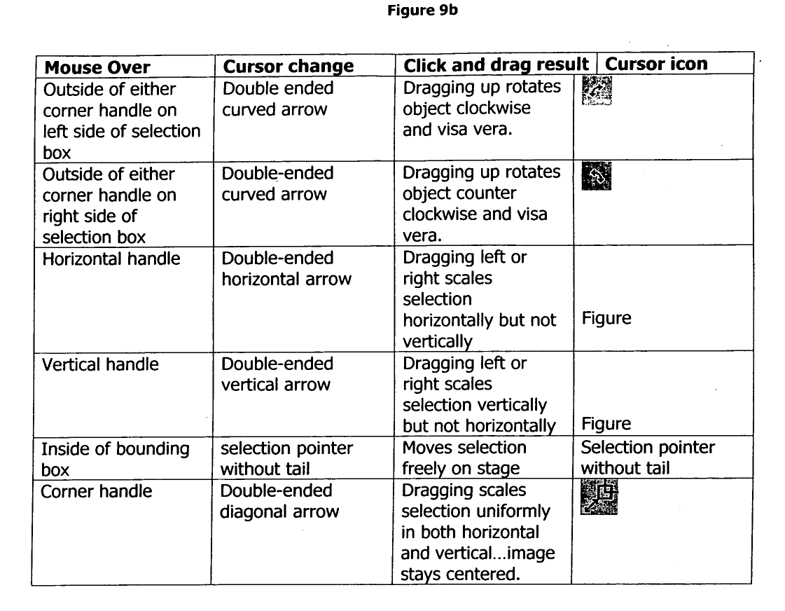

FIG. 9 illustrates an ear tab selection embodiment with sub-choices including left ear, right ear, and additional optional selections such as piercings and earrings and the like is contemplated here. Large extended ear lobes also becoming a part of today's fashions, and are also contemplated. In any event, the method and system is flexible to accommodate any change or fashion at will to provide an up to date or current selection for a user.

As illustrated in FIGS. 9a-9b, there is provided an embodiment which allows clicking on any part of a head feature choice with a selections tool to select a facial portion for adjustment or feature selections, such as to be uniformly seated. positioned or rotated. Preferably, for instance, once a part or portion is selected a component panel will update and bring to the forefront a tab corresponding to the selected portion. In another preferred embodiment, clicking and dragging a selection handle will result in the indicated behaviors.

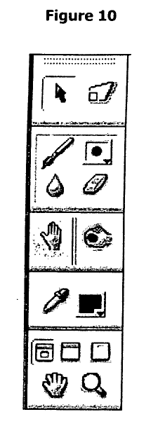

A composite editing tool depiction is illustrated in FIG. 10, which may contain such elements as, for instance, without limitation, selection tool; distort/skews painting tool; blur tool; eraser tool; dodge and burn tools; brush size tool; color picker tool; hand tool; standard full screen; full screen with menu; and full screen with buttons and a magnifying tool. The composite editing tool is a collection of iconic buttons for choosing a tool that a user may want to employ to modify the composite image on a “stage”, for example, in view of a witnesses' comments. The selected tool preferably indicates that it is selected by either appearing in a pressed state, or by changing its look to be a selected state. Each tool may have a tool tip to indicate the name of the tool, and perhaps a shortcut key for its selection.

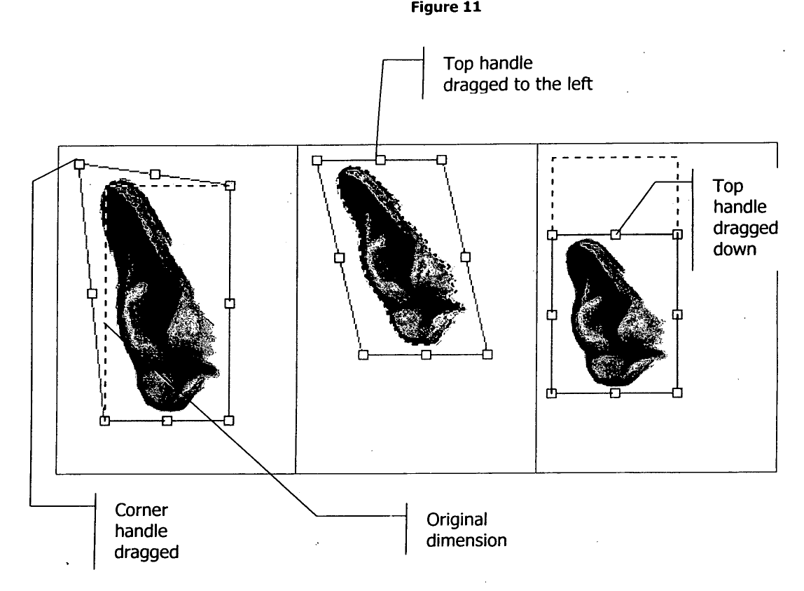

In FIG. 11, a distort tool embodiment is illustrated as in the case of an ear feature in this example. As shown in some preferred embodiments, selecting the distort tool allows a user to apply free distortion to any selected component and any pixels that have been painted over the component. Dragging any selected box handle, as shown, will distort a selected component in a manner or direction as desired.

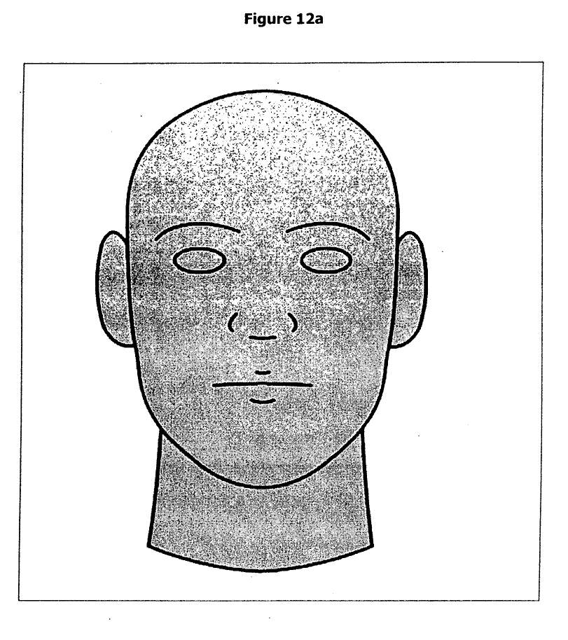

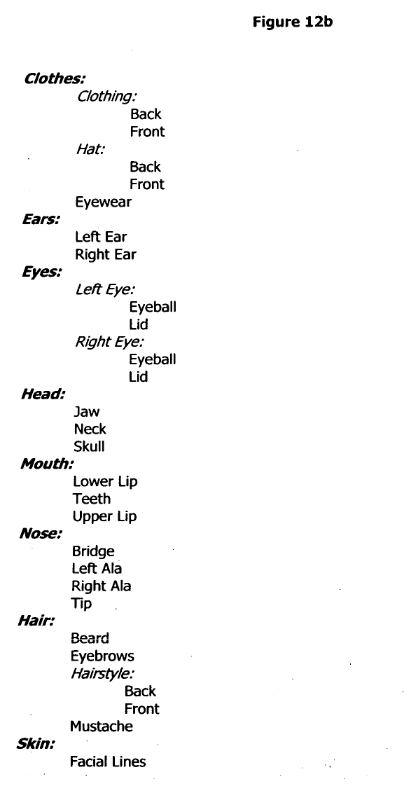

A chart shown as illustrated in FIGS. 12a and 12b shows an example of a head element behavior chart. Components with symmetry can have their symmetrical linking broken on the fly by, for example, ALT+clicking on the component with symmetry and dragging that selection. The selection then moves independently from the original pairing, such as if the user wants to move, scale or rotate an ear.

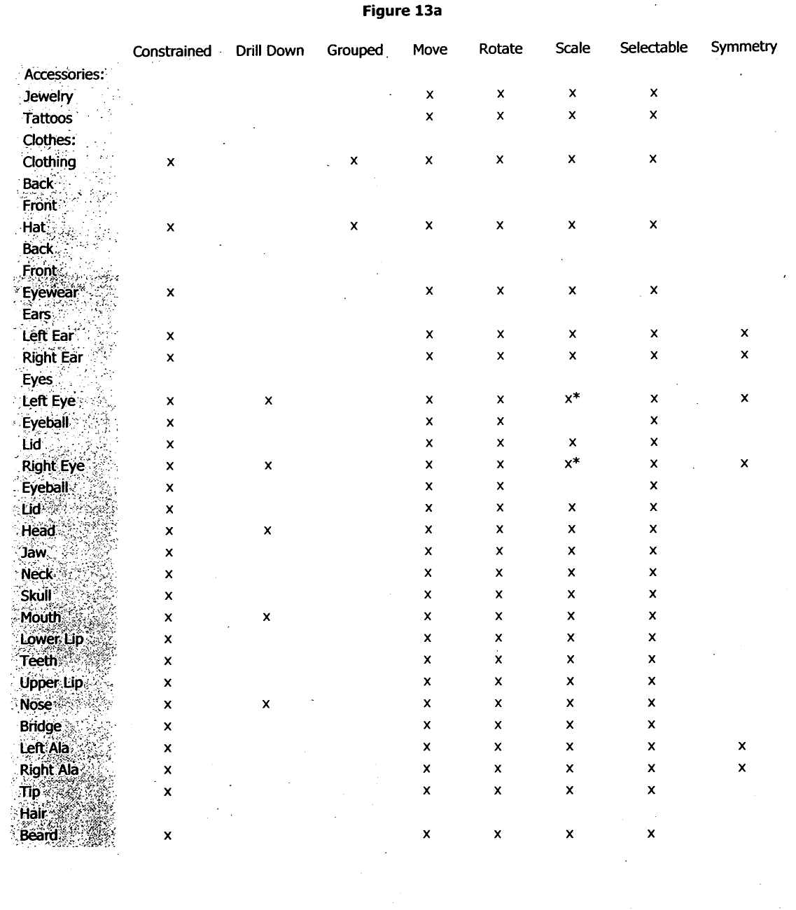

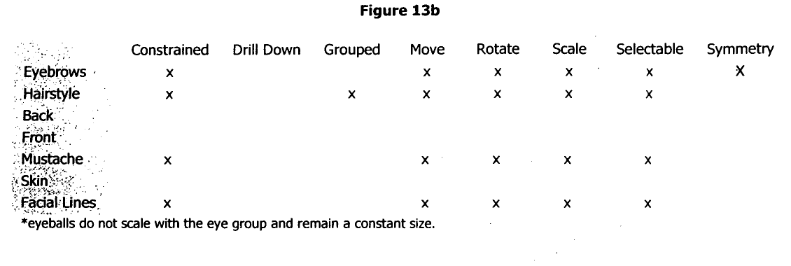

As illustrated in FIGS. 13a and 13b, a selection of several elements or features may be enabled as indicated. Each element of feature may have multiple behaviors such as Constrained, Dull Down, Grouped, Move, Rotate, Selectable and Symmetry.

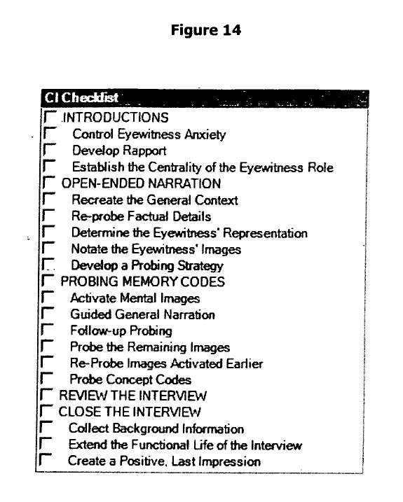

A checklist feature is illustrated in FIG. 14 which is designed to assist a user-interviewer in following the Cognitive Interview Process.

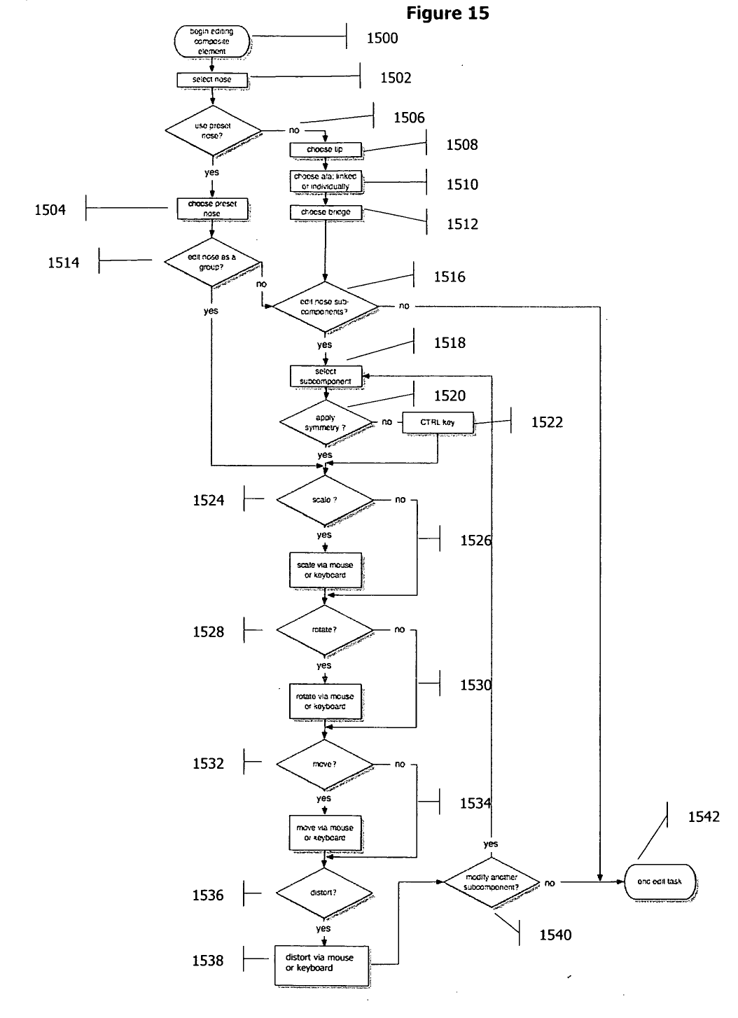

A preferred embodiment of operation of the inventive method and system is illustrated by way of a flowchart in FIG. 15. As shown, a user begins editing a composite element in 1500, and a nose is selected 1502. A decision is made to use the nose “as is” 1502, or to modify it 1506, and choose a particular style of a tip 1508 and/or choose an ala linked or individually 1510, and to choose a bridge 1512. The nose chosen may be also edited as a group 1514, or the subcomponents of the nose edited 1516, in which case a subcomponent is selected 1518 and symmetry applied as desired 1520, or bypassed by a CTRL key 1522. An option of nose scale is then decided 1524, or bypassed 1526, and the nose rotated as desired 1528 or bypassed 1530. The position of the chosen nose embodiment may next be moved on the selected head/face portion 1532, or bypassed 1534, and distorted as desired 1536, as moved by a mouse device or by the keyboard 1538. Any other facial feature or component or portion thereof may be so modified 1540, in which case an end edit task is reached 1542.

It is further contemplated that the method and system of the invention be usable with remotely placed witnesses who may be interviewed, for example, by e-mail and feature selections reviewed and entered accordingly, or any other medium or venue enabling receiving and transmitting of text and/or images, graphics and the like, such as Multimedia Messaging Service (“MMS”) enabled wireless phone devices and the like. In this embodiment a recollection fresh in the mind of a remotely located witness may be saved from degradation by time or other factors where viewing a line-up or mugshot is not possible, and an efficient and accurate likeness reconstruction obtained from a reasonably fresh recollection by implementing the inventive method by wireless and/or email/Internet-enabled means.

Yet still in other embodiments, there may optionally be employed a “Facial Finger Print” feature, in which the degree of approximation in likeness of a facial reconstruction to that of a photo of a known suspect, or perhaps several, will trigger an alarm of sorts, and, for instance, indicate a numerical percentage match, and also indicating a progression in the right (or wrong) direction with respect to chosen facial features and/or accessories etc. Such a network link with another database, such as maintained on a remote server, will allow for convenient integration with other law enforcement data applications, or use from such remote locations as a patrol car, police beat etc., or even rapid global identification.

As shown, by way of using relatively few groupings of facial features and accessories, in accordance with the inventive method coupled with other modification capability a user/witness team may create many different juvenile and adult facial likeness reconstructions of any sex or nationality rapidly and accurately.

In still yet another aspect of the Invention, it is further contemplated that the Method and System of likeness reconstruction be employed in conjunction with one or more business functions, such as designing, manufacturing, licensing, leasing, marketing and selling the inventive subjective matter, or in the formation of a business entity, be it a corporation or joint venture or partnership, or to generated business good will or valuable trademark rights.

It will be further appreciated by those persons skilled in the art that the embodiments described herein are merely illustrative of the principals of the invention, and are not intended to limit the spirit of the invention or claims in any way as many modifications and variations are possible without departing from the spirit and scope of the invention.

We claim:

1. A method for facilitating facial image reconstruction of a human being comprising interviewing a witness with respect to the human being's head and facial facts; offering the witness a pre-selected menu of groups of each of a plurality of different races and mixed races of head types and facial features to choose from; and then depicting positive choices on a visual screen, and wherein said steps are effective to facilitate fabrication of said facial image.

2. The method of claim 1 wherein said facial image reconstruction in progress is not visible to an interviewed witness, and/or a portion of said facial image reconstruction in progress is not visible to said interviewed witness.

3. The method of claim 1 wherein said pre-selected groups of facial features comprise from 1 to about 30 noses, from 1 to about 30 mouths, from 1 to about 30 eye styles, from 1 to about 30 foreheads, from 1 to about 30 chins, from 1 to about 30 hairlines, from 1 to about 30 complexions, from 1 to about 30 iris styles, and from 1 to about 30 heads of any of the known races and/or mixed races.

4. The method of claim 1 wherein said pre-selected groups compromise from 1 to about 20 noses, from 1 to about 20 mouths, from 1 to about 20 eye styles, from 1 to about 20 foreheads, from 1 to about 20 chins, from 1 to about 20 hairlines, from 1 to about 20 complexions, from 1 to about 20 iris styles, and from 1 to about 20 heads of any of the known races and/or mixed races.

5. The method of claim 1 wherein each chosen facial feature is able to be manipulated in spatial and/or topological relationship relative to a head portion and/or moved, and/or distorted.

6. The method of claim 3 wherein each chosen facial feature is able to be manipulated in spatial and/or topological relationship relative to a head portion and/or moved and/or distorted.

7. The method of claim 1 wherein facilitating facial image reconstruction comprises providing access to software for fabrication of said facial image.

8. The method of claim 2 wherein facilitating facial image reconstruction comprises providing access to software for fabrication of said facial image.

9. The method of claim 3 wherein facilitating facial image reconstruction comprises providing access to software for fabrication of said facial image.

10. The method of claim 4 wherein facilitating facial image reconstruction comprises providing access to software for fabrication of said facial image.

11. The method of claim 5 wherein facilitating facial image reconstruction comprises providing access to software for fabrication of said facial image.

12. The method of claim 6 wherein facilitating facial image reconstruction comprises providing access to software for fabrication of said facial image.

13. The method of claim 1 wherein facilitating facial image reconstruction comprises identifying at least one external body condition and modifying the image to reflect evolution of the external body condition.

14. The method of claim 1 further comprising enabling the witness to view the progress of fabrication of the facial image from a plurality of different viewing perspectives.

15. The method of claim 1 wherein said facial feature is selected from the group of noses, eyes, eye coloring, eyebrows, mouths, chins, foreheads, cheeks, ears, hair, hairlines, facial coloring, teeth, lips, hair coloring, facial deformities, including bruises, scars, freckles, pimples, facial lines, wrinkles, blackheads, and moles, facial and head accessories, including eyeglasses, contact lenses, sunglasses, earrings, piercings, including nose, eye and face rings, beards and facial hair, toupees, tattoos, facial makeup and cosmetics, and mixtures thereof, and wherein said head type is selected from North American, European, Caucasian, Latin, Asian, African American, Negro, African, American Indian, India and/or mixtures thereof.

16. The method of claim 1 wherein said head type and/or facial features are offered in finite groups from a plurality of age selections.

17. The method of claim 1 wherein said head type and/or said facial features may be offered in conjunction with lifestyle accessories including uniform or military attire, biker garb, office worker attire, police officer attire, construction worker attire, hospital and health industry attire, and student attire.

18. The method of claim 1 wherein said head type, facial features and/or portions thereof may be made to a witness to appear to gradually age in appearance.

19. The method of claim 1 wherein likeness reconstruction is accomplished in conjunction with layering opacity and overlay images.

20. The method of claim 1 wherein at any point in the facial image reconstruction process the image completed up to said point may be compared in similarity to the images of one or more known human beings by computer software to ascertain numerically the percentage degree of a match or the percentage degree of a non-match with said compared images.

21. The method of claim 1 wherein said facial reconstruction is accomplished in a location remote from said witness by way of a wireline or wireless Multi Messaging Service enabled phone device, and/or Internet and/or Internet enabled device.

22. A method of conducting any of an array of different business methods comprising the method of claim 1.
